(19) United States
(12) Patent Application Publication
(10) Pub. No.: US 2026/0308043 A1
(43) Pub. Date: Oct. 8, 2026

(54) APPARATUS AND METHOD FOR MANUFACTURING GLASS FILM

(71) Applicant: Nippon Electric Glass Co., Ltd., Shiga (JP)

(72) Inventor: Naohiro IKAI, Otsu-shi, Shiga (JP)

(21) Appl. No.: 19/481,348

(22) PCT Filed: Jul. 8, 2024
(86) PCT No.: PCT/JP2024/024576

§ 371 Date: Nov. 4, 2025

(30) Foreign Application Priority Data
Jul. 12, 2023 (JP) 2023-114458

(51) Int. Cl. C03B 35/14; C03B 17/06; C03B 33/08

(52) U.S. Cl. CPC C03B 35/14; C03B 33/082; C03B 17/064; C03B 2225/00

(57) ABSTRACT

Provided is a production apparatus (1) for a glass film, comprising: a suction and support body (20a) configured to allow suction and support of a lower surface of a glass film (G); a suction device (21a) configured to generate a suction force on the suction and support body (20a); a processing apparatus (19a) configured to process the glass film (G) in a suctioned and supported state; a flow meter (29), which is provided to a main pipe (27a) of the suction device (21a), and is configured to measure a suction flow rate in the main pipe (27a); and a flow control device (28) configured to control the suction flow rate based on a measured value obtained by the flow meter (29).

### TECHNICAL FIELD

The present invention relates to a production apparatus and a production method for a glass film.

### BACKGROUND ART

For example, in Patent Literature 1, there is disclosed a method of producing a glass film including: conveying step of conveying a glass film in a predetermined direction with a conveying device; and a cutting step of melt-cutting the glass film into a first portion and a second portion with a cutting portion while conveying the glass film through the conveying step.

The cutting portion includes: a laser irradiation apparatus configured to radiate a laser beam to the glass film; and a surface plate configured to support part of the glass film. The surface plate has an opening that allows suction of the glass film. This opening is connected to a suction pump through intermediation of a pipe (see the paragraphs 0032, 0035, and 0037, and FIG. 4 of Patent Literature 1).

In the cutting step, part of the glass film is deformed so as to protrude downward by suction of the glass film through the opening in the surface plate. Then, a laser beam is radiated to the deformed part of the glass film from the laser irradiation apparatus to thereby melt-cut an irradiated portion (see the paragraphs 0046, 0047, and 0054, and FIG. 6 of Patent Literature 1).

### CITATION LIST

Patent Literature 1: JP 2017-214241 A

### SUMMARY OF INVENTION

### Technical Problem

With the above-mentioned method of producing a glass film, in order to cut a glass film with high accuracy, it is desirable to maintain a suction force on the surface plate to suction the glass film constant. With the related-art method, however, molten glass generated when the glass film is melt-cut may intrude into the pipe for suction through the opening of the surface plate, resulting in that the suction force on the surface plate may become unstable.

The present invention has been made in view of the above-mentioned circumstances, and a technical object of the present invention is to control a suction force to suction a glass film to be constant.

### Solution to Problem

(1) In order to solve the above-mentioned problem, according to the present invention, there is provided a production apparatus for a glass film, comprising: a suction and support body configured to allow suction and support of a lower surface of a glass film; a suction device configured to generate a suction force on the suction and support body; a processing apparatus configured to process the glass film in a suctioned and supported state; a flow meter, which is provided to a main pipe of the suction device, and is configured to measure a suction flow rate in the main pipe; and a flow control device configured to control the suction flow rate based on a measured value obtained by the flow meter.

According to the above-mentioned configuration, the suction flow rate in the main pipe is measured with the flow meter provided to the main pipe of the suction device, and the suction flow rate is controlled based on the measured value obtained by the flow meter. Thus, the suction force on the suction and support body to suction the glass film can be controlled to be constant.
(2) In the production apparatus for a glass film according to the above-mentioned item (1), the flow control device may comprise: a damper configured to adjust an introduction amount of outside air to be introduced into the main pipe; and a control unit configured to control an opening and closing amount of the damper based on the measured value obtained by the flow meter. When the measured value obtained by the flow meter is equal to or less than a lower-limit threshold value, the control unit may be configured to control the damper in a closing direction to increase the suction flow rate. When the measured value obtained by the flow meter is equal to or more than an upper-limit threshold value, the control unit may be configured to control the damper in an opening direction to reduce the suction flow rate.

According to the above-mentioned configuration, when the suction flow rate measured with the flow meter is equal to or less than the lower-limit threshold value, the damper can be controlled by the control unit in the closing direction to t increase the suction flow rate in the main pipe. As a result, a reduction in suction force on the suction and support body to suction the glass film can be prevented.

Meanwhile, when the suction flow rate measured with the flow meter is equal to or more than the upper-limit threshold value, the damper can be controlled by the control unit in the opening direction to reduce the suction flow rate in the main pipe. As a result, an excessive increase in suction force on the suction and support body to suction the glass film can be prevented.
(3) In the production apparatus for a glass film according to the above-mentioned item (2), the damper may be provided to a branch pipe connected to the main pipe.

Dust and debris, which result from processing of the glass film, pass through the main pipe in some cases. Thus, a situation in which the main pipe is clogged with dust and debris can be avoided by providing the damper not to the main pipe but to the branch pipe.
(4) In the production apparatus for a glass film according to the above-mentioned item (3), the flow meter may be provided to the main pipe on an upstream side of the branch pipe.

According to the above-mentioned configuration, the suction flow rate in the main pipe is measured with the flow meter on an upstream side of the branch pipe to which the damper is provided. As a result, the suction force on the suction and support body to suction the glass film can be measured with high accuracy.
(5) In the production apparatus for a glass film according to any one of the above-mentioned items (1) to (4), the flow meter may be an ultrasonic flow meter.

According to the above-mentioned configuration, the flow meter can be installed outside of the main pipe. As a result, clogging with dust and debris can be effectively prevented in comparison with a case in which the flow meter is provided inside the main pipe.
(6) In the production apparatus for a glass film according to any one of the above-mentioned items (1) to (5), the suction device may comprise a plurality of the suction devices with different suction forces, and the production apparatus may further comprise a switching device configured to perform switching between the plurality of suction devices.

According to the above-mentioned configuration, the suction force on the suction and support body to suction the glass film can be appropriately controlled by selecting a suction device that is suitable for dimensions, such as a thickness, of the glass film to be produced.
(7) In the production apparatus for a glass film according to any one of the above-mentioned items (1) to (6), the production apparatus may further comprise a conveying device configured to move the glass film in a state of being suctioned onto the suction and support body, and the processing apparatus may be a laser irradiation apparatus configured to radiate a laser beam to the glass film being moved on the suction and support body to cut end portions of the glass film in a width direction.

According to the above-mentioned configuration, the glass film can be suitably cut by radiating the laser beam from the laser irradiation apparatus to the glass film while conveying the glass film with the conveying device.
(8) In the production apparatus for a glass film according to the above-mentioned item (7), the laser irradiation apparatus may comprise: a first laser irradiation apparatus configured to cut one end portion of the glass film in the width direction; and a second laser irradiation apparatus configured to cut another end portion of the glass film in the width direction, the suction and support body may comprise: a first suction and support body corresponding to the first laser irradiation apparatus; and a second suction and support body corresponding to the second laser irradiation apparatus, and the main pipe may comprise: a first main pipe connected to the first suction and support body; and a second main pipe connected to the second suction and support body.

According to the above-mentioned configuration, the one end portion and the another end portion of the glass film in the width direction can be cut with the laser irradiation apparatus and the suction and support bodies, respectively.
(9) In the production apparatus for a glass film according to the above-mentioned item (8), the main pipe may comprise a third main pipe that connects the first main pipe and the second main pipe to each other.

One suction device can be used to serve as both a suction device connected to the first suction and support body and a suction device connected to the second suction and support body through connection of the first main pipe and the second main pipe to each other with the third main pipe as described above. As a result, a configuration of the production apparatus for a glass film can be simplified.
(10) In order to solve the above-mentioned problem, according to the present invention, there is provided a production method for a glass film, comprising a processing step of processing a glass film with a processing apparatus under a state in which a lower surface of the glass film is suctioned onto and supported by a suction and support body. In the processing step, a suction force is generated on the suction and support body by a suction device that is connected to the suction and support body through a main pipe. In the processing step, a suction flow rate in the main pipe is measured with a flow meter provided to the main pipe and the suction flow rate in the main pipe is controlled by a flow control device based on the measured suction flow rate.

According to the above-mentioned configuration, in the processing step, the suction flow rate in the main pipe is measured with the flow meter provided to the main pipe of the suction device and the suction flow rate is controlled based on the measured value obtained by the flow meter. In this manner, the suction force on the suction and support body to suction the glass film can be controlled to be constant.
(11) In the production method for a glass film according to the above-mentioned item (10), the glass film may be moved in a state of being suctioned onto the suction and support body, and in the processing step, a laser beam may be radiated to the glass film being moved on the suction and support body, thereby cutting end portions of the glass film in a width direction.

### Advantageous Effects of Invention

According to the present invention, the suction force to suction the glass film can be controlled to be constant.

### BRIEF DESCRIPTION OF DRAWINGS

FIG. 1 is a side view of a production apparatus for a glass film in a first embodiment.

FIG. 2 is a plan view of the production apparatus for a glass film.

FIG. 3 is a sectional view of a surface plate.

FIG. 4 is a plan view of the surface plate and a suction device.

FIG. 5 is a front view of the surface plate and the suction device.

FIG. 6 is a sectional view for illustrating a cutting step.

FIG. 7 is a sectional view for illustrating the cutting step.

FIG. 8 is a plan view for illustrating a flow control device for a production apparatus for a glass film according to a second embodiment.

### DESCRIPTION OF EMBODIMENTS

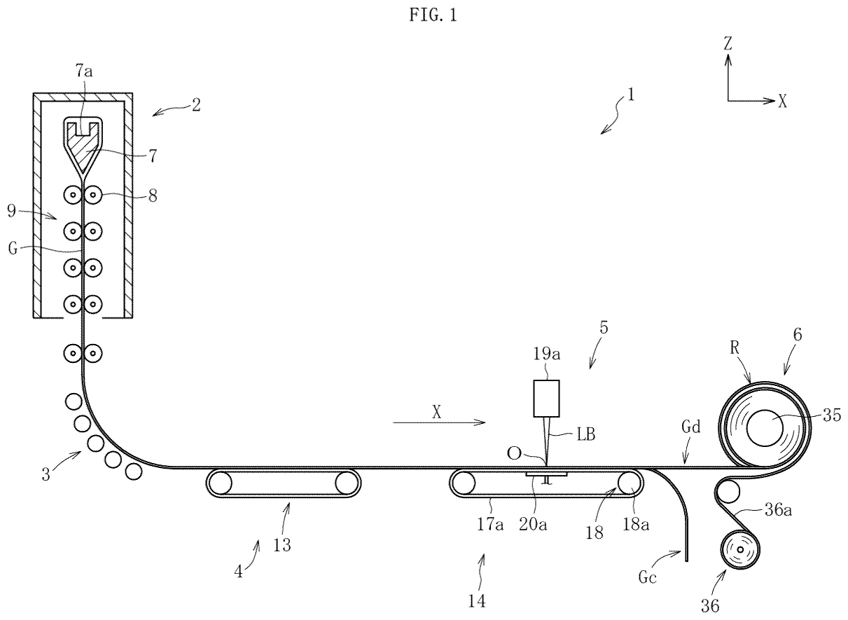

Now, an embodiment of the present invention is described with reference to the drawings. Each of FIG. 1 to FIG. 7 shows a first embodiment of each of a production apparatus and a production method for a glass film according to the present invention.

As illustrated in FIG. 1, a production apparatus 1 comprises: a forming portion 2 configured to form a glass film G; a direction conversion portion 3 configured to convert a traveling direction of the glass film G from a vertically downward direction to a lateral direction X; a lateral conveying portion 4 configured to convey the glass film G in the lateral direction X after the direction conversion; a cutting portion 5 configured to cut end portions (selvage portions) Ga and Gb of the glass film G in a width direction as non-product portions Gc while the glass film G is conveyed in the lateral direction X with the lateral conveying portion 4; and a take-up portion 6 configured to take up a product portion Gd into a roll shape to form a glass roll R, the product portion Gd being obtained by cutting and removing the non-product portions Gc with the cutting portion 5.

In this embodiment, the thickness of the product portion Gd is set to 300 μm or less, preferably 100 μm or less.

The forming portion 2 is configured to cause the molten glass overflowing from an upper portion of an overflow groove 7a of a forming body 7 to flow down along both side surfaces of the forming body 7 to be joined at a lower end of the forming body 7, to thereby form a molten glass in a film shape. That is, the forming portion 2 performs the forming of glass by using an overflow down-draw method. An annealer 9 is configured to perform strain removal treatment on the glass film G.

The lateral conveying portion 4 is arranged in front of (on a downstream side of) the direction conversion portion 3 in the traveling direction of the glass film G. The lateral conveying portion 4 comprises: a first conveying device 13; and a second conveying device 14. The first conveying device 13 is arranged on a downstream side of the direction conversion portion 3, and the second conveying device 14 is arranged on a downstream side of the first conveying device 13.

The second conveying device 14 is a component of the cutting portion 5. The second conveying device 14 comprises: a plurality of (in this example, three) conveyor belts 17a to 17c each configured to convey the glass film G; and a driver 18 for the conveyor belts 17a to 17c.

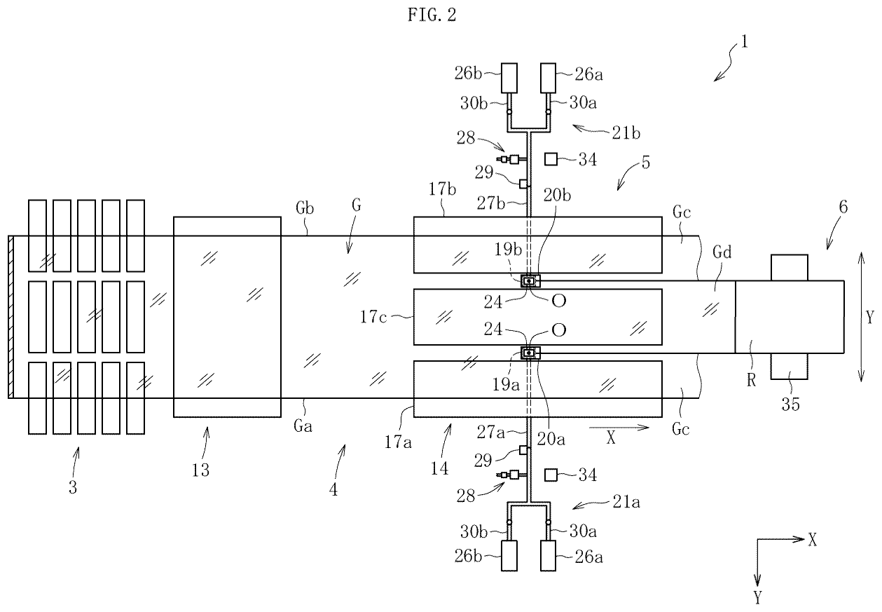

As illustrated in FIG. 2, the conveyor belts 17a to 17c comprise: the first conveyor belt 17a to be brought into contact with the one end portion Ga of the glass film G in the width direction; the second conveyor belt 17b to be brought into contact with the other end portion Gb of the glass film G in the width direction; and the third conveyor belt 17c to be brought into contact with a middle portion of the glass film G in the width direction.

The driver 18 comprises: a driving body 18a for driving the conveyor belts 17a to 17c, such as a roller or a sprocket; and a motor (not shown) configured to rotate the driving body 18a.

As illustrated in FIG. 2, the conveyor belts 17a to 17c are arranged so as to be spaced apart from one another in the width direction Y of the glass film G. Accordingly, gaps are formed between the first conveyor belt 17a and the third conveyor belt 17c and between the second conveyor belt 17b and the third conveyor belt 17c.

As illustrated in FIG. 1 to FIG. 3, the cutting portion 5 comprises, in addition to the second conveying device 14: laser irradiation apparatus 19a and 19b as processing apparatus provided at positions above the second conveying device 14; surface plates 20a and 20b as suction and support bodies configured to allow suction and support of a lower surface of the glass film G; and suction devices 21a and 21b configured to generate suction forces on the surface plates 20a and 20b.

The laser irradiation apparatus 19a and 19b comprise: a first laser irradiation apparatus 19a configured to cut the one end portion Ga of the glass film G in the width direction; and a second laser irradiation apparatus 19b configured to cut the another end portion Gb of the glass film G in the width direction. The laser irradiation apparatus 19a and 19b each have a configuration in which the laser beam LB, such as a CO₂ laser, a YAG laser, or any other laser, is radiated downward. The laser beam LB is radiated to a predetermined position (irradiation position) 0 of the glass film G.

As illustrated in FIG. 2, the irradiation positions O with the laser beam LB radiated from each of the laser irradiation apparatus 19a and 19b are set so as to correspond to the gap between the first conveyor belt 17a and the third conveyor belt 17c and the gap between the second conveyor belt. 17b and the third conveyor belt 17c in the second conveying device 14.

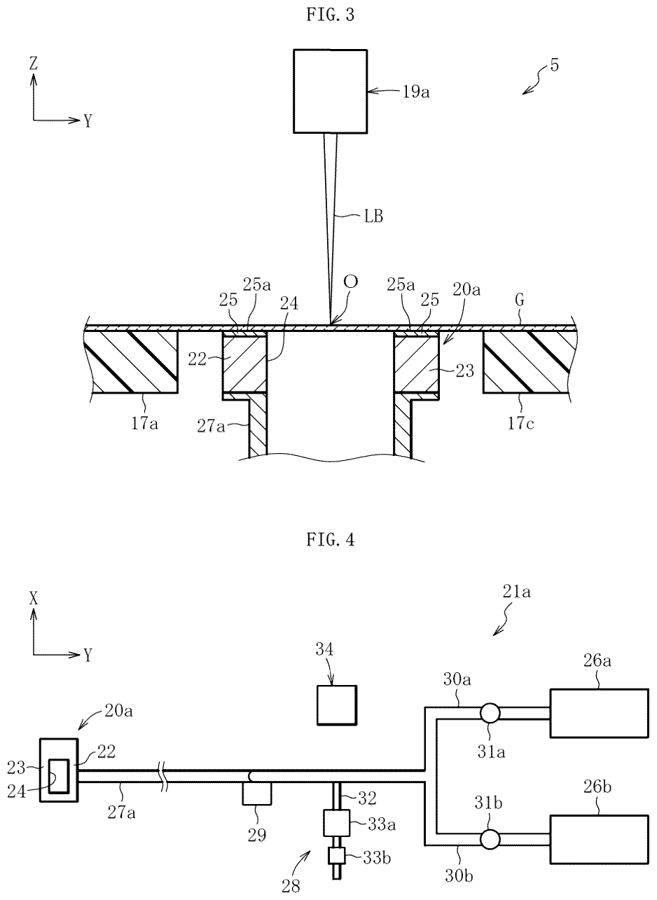

As illustrated in FIG. 2 and FIG. 3, the surface plates 20a and 20b are arranged at positions below the laser irradiation apparatus 19a and 19b, respectively. The surface plates 20a and 20b comprise: a first surface plate 20a (first suction and support body) corresponding to the first laser irradiation apparatus 19a; and a second surface plate 20b (second suction and support body) Corresponding to the second laser irradiation apparatus 19b. The first surface plate 20a is arranged in the gap between the first conveyor belt 17a and the third conveyor belt 17c of the second conveying device 14. The second surface plate 20b is arranged in the gap between the second conveyor belt 17b and the third conveyor belt 17c.

The surface plates 20a and 20b are each made of a metal, and each comprise: a first support 22 configured to support the non-product portion Gc; a second support 23 configured to support the product portion Gd, and an opening 24 formed between the first support 22 and the second support 23 (see FIG. 3).

As illustrated in FIG. 3, the first support 22 and the second support 23 comprise resin sheets 25 on upper portions thereof, respectively. with the resin sheets 25, the first support 22 and the second support 23 are configured to allow easy sliding of part of the glass film G passing over the surface plates 20a and 20b. The first support 22 is configured to support the glass film G (non-product portion Go) with an upper surface 25a of the resin sheet 25, which is provided on the first support 22. The upper surface 25a is hereinafter referred to as “support surface” of each of the supports 22 and 23.

The opening 24 has predetermined width and length dimensions, and is formed into an elongated shape along a conveyance direction (lateral direction X) of the glass film G. The opening 24 is formed as a hole vertically extending through the surface plates 20a and 20b. The suction devices 21a and 21b are connected to the opening 24. With such configuration, the opening 24 functions as a suction hole configured to suction the glass film G passing over the surface plates 20a and 20b.

The laser irradiation apparatus 19a and 19b are arranged above the opening 24. Accordingly, the laser irradiation apparatus 19a and 19b can radiate the laser beam LB to the glass film G within a range of the opening 24.

As illustrated in FIG. 2 and FIG. 4, the suction devices 21a and 21b comprise: a first suction device 21a connected to the first surface plate 20a; and a second suction device 21b connected to the second surface plate 20b. Each of the suction devices 21a and 21b comprises: dust collection pumps 26a and 26b; a main pipe 27a, 27b that connects the surface plate 20a, 20b and the dust collection pumps 26a and 26b to each other; and a flow control device 28 configured to control a flow rate of gas to be suctioned (hereinafter referred to as “suction flow rate”) into the main pipe 27a, 27b through the surface plate 20a, 20b.

The dust collection pumps 26a and 26b comprise a first dust collection pump 26a and a second dust collection pump 26b with different suction forces. In this embodiment, the suction force of the first dust collection pump 26a is larger than the suction force of the second dust collection pump 26b.

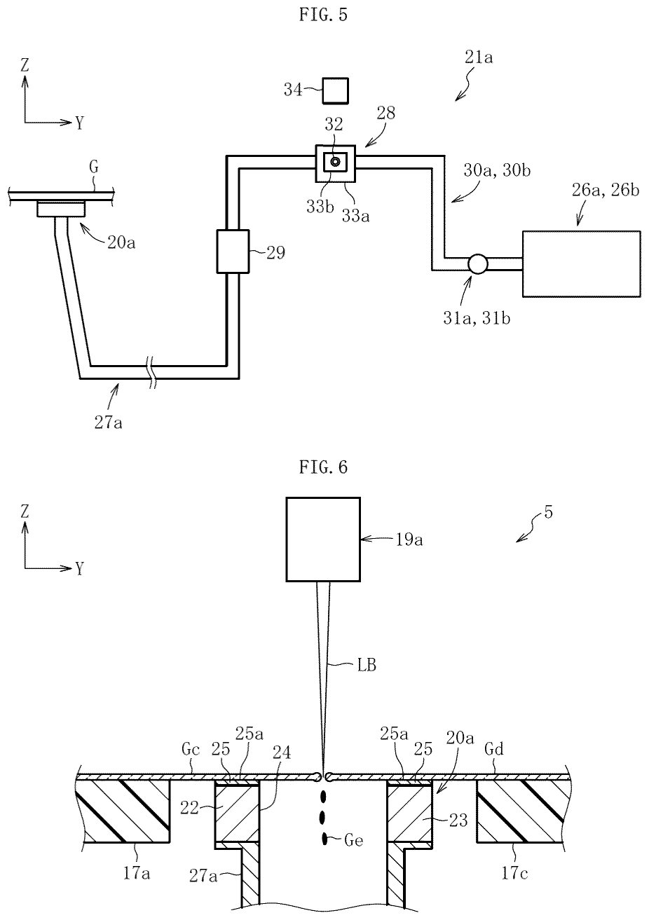

As illustrated in FIG. 2, FIG. 4, and FIG. 5, the main pipes 27a and 27b comprise: a first main pipe 27a that connects the first surface plate 20a and the first dust collection pump 26a to each other; and a second main pipe 27b that connects the second surface plate 20b and the second dust collection pump 26b to each other. The first main pipe 27a and the second main pipe 27b are each configured as an independent pipe.

Each of the main pipes 27a and 27b has a flow meter 29 configured to measure the suction flow rate, at an intermediate portion thereof. The flow meter 29 is formed of, for example, an ultrasonic flow meter. The ultrasonic flow meter 29 can measure the suction flow rate under a state of being mounted to an outer portion of the main pipe 27a, 27b, and hence is more advantageous than a propeller flow meter in that the main pipe 27a, 27b is prevented from being clogged with dust and debris generated as a result of cutting of the glass film G.

As the ultrasonic flow meter 29, for example, a transit-time ultrasonic flow meter is suitably used. However, a measurement method of the flow meter 29 is not limited to that used in this embodiment.

Each of the main pipes 27a and 27b comprises: a first connecting portion 30a connected to the first dust collection pump 26a; and a second connecting portion 30b connected to the second dust collection pump 26b. The first connecting portion 30a comprises a first on-off valve 31a at an intermediate portion thereof, and the second connecting portion 30b comprises a second on-off valve 31b at an intermediate portion thereof.

The first on-off valve 31a and the second on-off valve 31b function as devices configured to perform switching between the first dust collection pump 26a and the second dust collection pump 26b to be used. That is, when the first dust collection pump 26a is used, the first on-off valve 31a is brought into an open state, and the second on-off valve 31b is brought into a closed state. Further, when the second dust collection pump 26b is used, the first on-off valve 31a is brought into a closed state, and the second on-off valve 31b is brought into an open state.

The flow control device 28 controls the suction flow rate based on a measured value obtained by the flow meter 29. The flow control device 28 comprises: a branch pipe 32 provided at an intermediate portion of the main pipe 27a, 27b; dampers 33a and 33b provided to the branch pipe 32; and a control unit. 34 configured to control the dampers 33a and 33b based on the measured value obtained by the flow meter 29.

The branch pipe 32 functions as an introduction pipe that allows outside air to be introduced into the main pipe 27a, 27b. The branch pipe 32 is provided on a downstream side of a position at which the flow meter 29 is provided in the main pipe 27a, 27b. In other words, the flow meter 29 is located at a position on an upstream side of the branch pipe 32 in the main pipe 27a, 27b.

The dampers 33a and 33b are provided at an intermediate portion of the branch pipe 32. The dampers 33a and 33b are flow control valves configured to adjust the amount of outside air to be introduced into the main pipe 27a, 27b through the branch pipe 32. The dampers 33a and 33b comprise: a first damper 33a configured to be automatically controlled by the control unit 34; and a second damper 33b configured to be manually controlled. The dampers 33a and 33b each adjust a flow rate of the outside air flowing from the branch pipe 32 into the main pipe 27a, 27b by adjusting an opening degree of internal blades.

The control unit 34 is formed of a computer that is connected to the first damper 33a and is capable of controlling an opening and closing operation of the first damper 33a. The control unit 34 controls the amount of opening and closing of the first damper 33a by controlling an opening and closing operation of the blades of the damper to thereby adjust the flow rate of outside air to be supplied from the branch pipe 32 into the main pipe 27a, 27b. The control unit 34 is connected to the flow meter 29, and is capable of receiving data relating to the suction flow rate measured with the flow meter 29.

In the control unit 34, threshold values of the suction flow rate, which serve as references for the operation of the first damper 33a, are set. The threshold values comprise an upper-limit threshold value and a lower-limit threshold value. When the measured value obtained by the flow meter 29 becomes equal to or less than the lower-limit threshold value, the control unit. 34 controls the blades of the first damper 33a in a closing direction to reduce an introduction amount of outside air to thereby increase the suction flow rate in the main pipe 27a, 27b. Further, when the measured value obtained by the flow meter 29 becomes equal to or more than the upper-limit threshold value, the control unit 34 controls the blades of the first damper 33a in an opening direction to increase the introduction amount of outside air to thereby reduce the suction flow rate in the main pipe 27a, 27b.

The take-up portion 6 is arranged on a downstream side of the cutting portion 5 and the second conveying device 14. The take-up portion 6 comprises: a take-up roller 35; a motor (not shown) configured to rotationally drive the take-up roller 35; and a protective sheet supply portion 36 configured to supply a protective sheet 36a to the take-up roller 35. The take-up portion 6 is configured to take up the product portion Gd into a roll shape by rotating the take-up roller 35 with the motor while causing the protective sheet 36a supplied from the protective sheet supply portion 36 to overlap the product portion Gd. The product portion Gd having been taken up forms the glass roll R.

A method of producing the glass film G (glass roll R) using the production apparatus 1 having the above-mentioned configuration is described below.

The method of producing the glass film G comprises: a forming step of forming the strip-shaped glass film G with the forming portion 2; a conveying step of conveying the glass film G with the direction conversion portion 3 and the lateral conveying portion 4; a processing step (hereinafter referred to as “cutting step”) of cutting the end portions Ga and Gb in the width direction of the glass film G in a suctioned and supported state with the cutting portion 5; and a take-up step of collecting the product portion Gd with the take-up portion 6 after the cutting step.

In the forming step, molten glass overflowing from an upper portion of the overflow groove 7a of the forming body 7 in the forming portion 2 is caused to flow down along both side surfaces of the forming body 7 to be joined at a lower end of the forming body 7, to thereby form the molten glass into a film shape. At this time, the shrinkage of the molten glass in a width direction is controlled with the cooling rollers 8, and thus the glass film G having a predetermined width is formed. After that, strain removal treatment is performed on the glass film G with the annealer 9.

In the conveying step, the conveying direction of the glass film G is converted to the lateral direction X with the direction conversion portion 3, and the glass film G is conveyed to the take-up portion 6 on a downstream side with the conveying devices 13 and 14.

The cutting step comprises a step of supporting part of the glass film G (hereinafter referred to as “supporting step”) by suctioning part of the lower surface of the glass film G onto the surface plates 20a and 20b. In the supporting step, suction forces are generated by the suction devices 21a and 21b on the surface plates 20a and 20b. In the supporting step, the glass film G is moved to a downstream side by the second conveying device 14 under a state in which the glass film G is suctioned onto the surface plates 20a and 20b.

In the supporting step, the first dust collection pump 26a or the second dust collection pump 26b is selected in accordance with dimensions of the glass film G to be cut. That is, when the glass film G having a large thickness dimension or width dimension is to be cut, the first dust collection pump 26a is selected. When the glass film G having a small thickness dimension or width dimension is to be cut, the second dust collection pump 26b is selected. In this embodiment, description is given of a case in which the first dust collection pump 26a is selected in each of the suction devices 21a and 21b. In this case, the first on-off valve 31a is brought into an open state, and the second on-off valve 31b is brought into a closed state. Further, the first dust collection pump 26a is actuated, and the second dust collection pump 26b is in a stop state.

In the cutting step, while the supporting step is being carried out, the glass film G is irradiated with the laser beam LB from the laser irradiation apparatus 19a and 19b of the cutting portion 5, and both the end portions Ga and Gb of the glass film G in the width direction are cut. Accordingly, the glass film G is separated into the non-product portions Gc and the product portion Gd.

Specifically, in the cutting step, the laser beam LB is radiated to the glass film G, which is moving while being suctioned through the opening 24 of each of the surface plates 20a and 20b, from the laser irradiation apparatus 19a and 19b. Part of the glass film G passing over the surface plates 20a and 20b is suctioned into the opening 24 by the action of the first dust collection pump 26a. At this time, the first support 22 and the second support 23 of each of the surface plates 20a and 20b slidably support the glass film G with the support surfaces 25a, respectively.

As illustrated in FIG. 3, the glass film G passing over the opening 24 is supported by the support surface 25a of the first support. 22 and the support surface 25a of the second support 23. When the suction forces on the surface plates 20a and 20b are constant, a height position of the glass film G is constant. Thus, the laser beam LB can be radiated to the irradiation position O with high accuracy.

When the laser beam LB is radiated to a deformed portion of the glass film G (see FIG. 3), part of the glass film G is melt-cut by heating with the laser beam LB (see FIG. 6). Molten glass Ge generated as a result of the melt-cutting is suctioned through the opening 24, and is collected by the first dust collection pump 26a through the main pipe 27a, 27b.

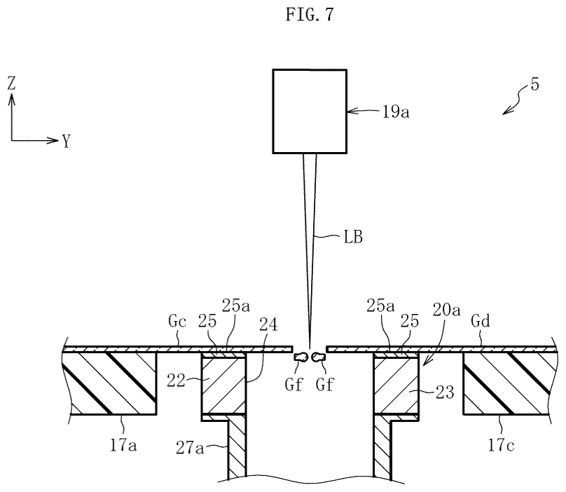

The non-product portions Gc and the product portion Gd of the glass film G are conveyed by the second conveying device 14. Thus, a melt-cut portion is moved away from the laser beam IB. As a result, the melt-cut portion is cooled to cause a heat strain therein, and a stress resulting therefrom acts as a tensile force on a portion that has not been melt-cut. Due to this action, as illustrated in FIG. 7, thread-like peeled materials Gf are generated from an end portion of each of the non-product portions Gc in the width direction and end portions of the product portion Gd in the width direction. The phenomenon in which the thread-like peeled material Gf is peeled off from each end portion as described above is generally called peeling.

The separated thread-like peeled materials Gf are moved downward under own weight thereof (see FIG. 7). After being separated from the non-product portions Gc or the product portion Gd, the thread-like peeled materials Gf are deformed in a helical shape. In the cutting step, the thread-like peeled materials Gf generated from the non-product portions Gc and the product portion Gd are collected with a collecting device (not shown) (collection step).

The non-product portions Go are conveyed to a downstream side by the first conveyor belt 17a and the second conveyor belt 17b of the second conveying device 14, and are collected by a collecting device (not shown) on an upstream side of the take-up portion 6.

The cutting step comprises a flow rate adjustment step of controlling the suction flow rate in the main pipe 27a, 27b with the flow control device 28.

In the flow rate adjustment step, the suction flow rate in the main pipe 27a, 27b is measured with the flow meter 29, and the suction flow rate in the main pipe 27a, 27b is controlled by the control unit 34 of the flow control device 28 based on a measured value of the suction flow rate.

The flow control device 28 sets the blades of each of the dampers 33a and 33b to have a predetermined opening degree at the start of the cutting step so that a constant amount of outside air is introduced from the branch pipe 32 into the main pipe 27a, 27b. The suction forces on the surface plates 20a and 20b, which are generated by the first dust collection pumps 26a, are set in consideration of the introduction amounts of outside air. In this case, numerical values measured with the flow meters 29 serve as reference values (initial values) of the suction flow rate.

When the measured value of the suction flow rate obtained by the flow meter 29 changes from the reference value, the flow control device 28 carries out the flow rate adjustment step. Specifically, the control unit 34 of the flow control device 28 periodically compares the suction flow rate measured with the flow meter 29, with the threshold value.

When the suction flow rate is equal to or less than the lower-limit threshold value, such case means that the suction force on the surface plate 20a, 20b has been reduced. In this case, the surface plate 20a, 20b cannot stably support the glass film G, and thus cutting accuracy may degrade.

When it is determined that the measured value obtained by the flow meter 29 is equal to or less than the lower-limit threshold value, the control unit 34 transmits a control signal to the first damper 33a to control the blades of the first damper 33a in a closing direction to thereby increase the suction flow rate in the main pipe 27a, 27b. In this manner, the amount of outside air introduced into the main pipe 27a, 27b through the branch pipe 32 is reduced to increase the suction force on the surface plate 20a, 20b to suction the glass film G.

When the suction flow rate is equal to or more than the upper-limit threshold value, such case means that the suction force on the surface plate 20a, 20b has been excessively increased. In this case, the glass film G may be damaged due to the excessive suction force.

When it is determined that the measured value obtained by the flow meter 29 is equal to or more than the upper-limit threshold value, the control unit 34 transmits a control signal to the first damper 33a to control the blades of the first damper 33a in an opening direction to thereby reduce the suction flow rate in the main pipe 27a, 27b. In this manner, the amount of outside air introduced into the main pipe 27a, 27b through the branch pipe 32 is increased to reduce the suction force on the surface plate 20a, 20b to suction the glass film G.

When the suction flow rate in the main pipe 27a, 27b is adjusted by the first damper 33a, the second damper 33b is maintained to have a constant opening degree. When, for example, the suction flow rate cannot be adjusted by the first damper 33a, the second damper 33b is operated manually.

In the take-up step, the product portion Gd having been conveyed with the second conveying device 14 is taken up into a roll shape with the take-up roller 35 of the take-up portion 6 while the protective sheet 36a is supplied to the product portion Gd from the protective sheet supply portion 36. When the product portion Gd having a predetermined length is taken up with the take-up roller 35, the glass roll R is produced.

With the above-mentioned production apparatus 1 and production method for the glass film G according to this embodiment, in the flow rate adjustment step, the suction flow rates in the main pipes 27a and 27b are measured with the flow meters 29 of the suction devices 21a and 21b, and the suction flow rates are controlled based on the measured values. As a result, the suction forces on the surface plates 20a and 20b to suction the glass film G can be controlled to be constant.

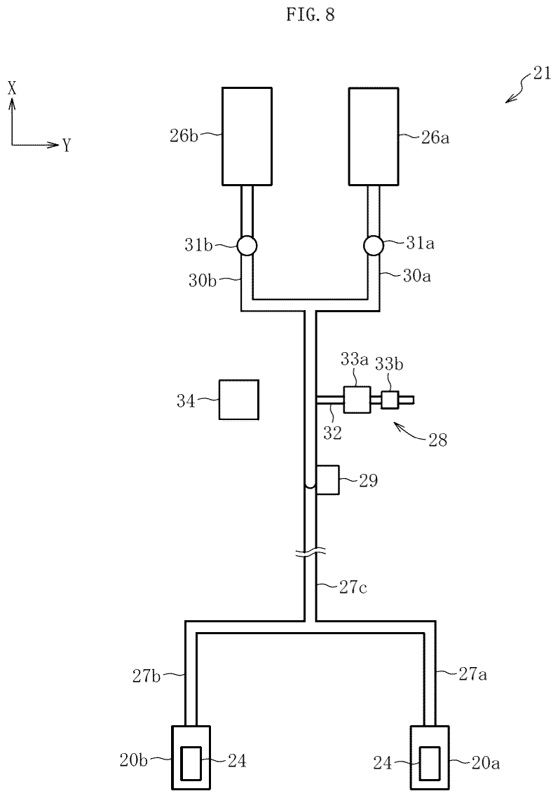

FIG. 8 shows a second embodiment of a production apparatus for a glass film. This embodiment is different from the first embodiment in a configuration of a suction device of the production apparatus. In this embodiment, a suction device 21 comprises a third main pipe 27c that connects a first main pipe 27a and a second main pipe 27b to each other. A flow meter 29 and a branch pipe 32 are provided at an intermediate portion of the third main pipe 27c.

The third main pipe 27c is connected to dust collection pumps 26a and 26b through intermediation of connecting portions 30a and 30b, respectively. The dust collection pumps 26a and 26b can generate suction forces on both a first surface plate 20a connected to the first main pipe 27a, and a second surface plate 20b connected to the second main pipe 27b.

According to this embodiment, the third main pipe 27c allows one suction device to serve both as a suction device connected to the first surface plate 20a, and as a suction device connected to the second surface plate 20b, through connection of the first main pipe 27a and the second main pipe 27b to the third main pipe 27c. In this manner, a structure of the production apparatus can be simplified.

The present invention is not limited to the configurations of the above-mentioned embodiments. In addition, the action and effect of the present invention are not limited to those described above. The present invention may be modified in various forms within the range not departing from the gist of the present invention.

In the above-mentioned embodiments, the laser irradiation apparatus 19a and 19b have been described as processing apparatus for the glass film G. However, the present invention is not limited to this configuration. Other examples of the processing apparatus include: an application apparatus configured to form a functional film on a surface of the glass film G; and a surface treatment apparatus configured to perform a predetermined treatment on the surface of the glass film G.

In the above-mentioned embodiments, description has been given as an example of the case in which the product portion Gd is taken up into a roll shape to form the glass roll R. However, the present invention is not limited to this mode. For example, the product portion Gd may be cut in the width direction into glass sheets each having a flat sheet shape.

Further, a publicly-known device or any appropriate means may be used as the flow meter 29 in the present invention as long as a flow rate value is ultimately obtained. Examples of the flow meter in the present invention include, as a flow meter in a broad sense, a measurement system comprising: a sensor device configured to measure a predetermined physical quantity; and a computation device configured to convert the physical quantity into a flow rate value.

Further, in the above-mentioned embodiments, description has been given as an example of the case in which the forming portion 2 performs the forming of glass by using the overflow down-draw method. However, the present invention is not limited to this mode. The present invention may perform the forming of glass by using a forming method such as a slot down-draw method, a roll-out method, or a float method. Further, the direction conversion portion 3 or the like may be omitted depending on the forming method.

Further, in the above-mentioned embodiments, description has been given as an example of the case in which a plurality of dampers comprising: the first damper 33a configured to be automatically controlled by the control unit 34; and the second damper 33b configured to be manually operated are provided as the dampers 33a and 33b. However, one damper that is controllable both automatically and manually may be provided instead. In this case, the number of dampers to be installed can be reduced. Further, in the above-mentioned embodiments, the case of the dampers being blade dampers have been given as an example. However, any types of dampers such as a slide gate type may be used as long as an opening amount of a damper is adjustable.

Further, in the above-mentioned embodiment, there has been described a mode in which the first main pipe 27a and the second main pipe 27b are connected to the third main pipe 27c. However, the first main pipe 27a and the second main pipe 27b may be connected to different pipes and different suction devices, respectively. In this case, the suction force on the first surface plate 20a and the suction force on the second surface plate 20b can be controlled independently of each other.

### REFERENCE SIGNS LIST

1 production apparatus for glass film
14 second conveying device
19a first laser irradiation apparatus (processing apparatus)
19b second laser irradiation apparatus (processing apparatus)
20a first surface plate (first suction and support body)
20b second surface plate (second suction and support body)
21 suction device
21a first suction device
21b second suction device
27a first main pipe
27b second main pipe
27c third main pipe
28 flow control device
29 flow meter
31a first on-off valve (switching device)
31b second on-off valve (switching device)
32 branch pipe
33a first damper
33b second damper
34 control unit
G glass film

1. A production apparatus for a glass film, comprising:
a suction and support body configured to allow suction and support of a lower surface of a glass film;
a suction device configured to generate a suction force on the suction and support body;
a processing apparatus configured to process the glass film in a suctioned and supported state;
a flow meter, which is provided to a main pipe of the suction device, and is configured to measure a suction flow rate in the main pipe; and
a flow control device configured to control the suction flow rate based on a measured value obtained by the flow meter.

2. The production apparatus for a glass film according to claim 1,
wherein the flow control device comprises:
a damper configured to adjust an introduction amount of outside air to be introduced into the main pipe; and
a control unit configured to control an opening and closing amount of the damper based on the measured value obtained by the flow meter,
wherein, when the measured value obtained by the flow meter is equal to or less than a lower-limit threshold value, the control unit is configured to control the damper in a closing direction to increase the suction flow rate, and
wherein, when the measured value obtained by the flow meter is equal to or more than an upper-limit threshold value, the control unit is configured to control the damper in an opening direction to reduce the suction flow rate.

3. The production apparatus for a glass film according to claim 2, wherein the damper is provided to a branch pipe connected to the main pipe.

4. The production apparatus for a glass film according to claim 3, wherein the flow meter is provided to the main pipe on an upstream side of the branch pipe.

5. The production apparatus for a glass film according to claim 1, wherein the flow meter is an ultrasonic flow meter.

6. The production apparatus for a glass film according to claim 1,
wherein the suction device comprises a plurality of the suction devices with different suction forces, and
wherein the production apparatus further comprises a switching device configured to perform switching between the plurality of suction devices.

7. The production apparatus for a glass film according to claim 1, further comprising a conveying device configured to move the glass film in a state of being suctioned onto the suction and support body,
wherein the processing apparatus is a laser irradiation apparatus configured to radiate a laser beam to the glass film being moved on the suction and support body to cut end portions of the glass film in a width direction.

8. The production apparatus for a glass film according to claim 7,
wherein the laser irradiation apparatus comprises:
a first laser irradiation apparatus configured to cut one end portion of the glass film in the width direction; and
a second laser irradiation apparatus configured to cut another end portion of the glass film in the width direction,
wherein the suction and support body comprises:
a first suction and support body corresponding to the first laser irradiation apparatus; and
a second suction and support body corresponding to the second laser irradiation apparatus, and
wherein the main pipe comprises:
a first main pipe connected to the first suction and support body; and
a second main pipe connected to the second suction and support body.

9. The production apparatus for a glass film according to claim 8, wherein the main pipe comprises a third main pipe that connects the first main pipe and the second main pipe to each other.

10. A production method for a glass film, comprising a processing step of processing a glass film with a processing apparatus under a state in which a lower surface of the glass film is suctioned onto and supported by a suction and support body,
wherein, in the processing step, a suction force is generated on the suction and support body by a suction device that is connected to the suction and support body through a main pipe, and
wherein, in the processing step, a suction flow rate in the main pipe is measured with a flow meter provided to the main pipe, and the suction flow rate in the main pipe is controlled by a flow control device based on the measured suction flow rate.

11. The production method for a glass film according to claim 10,
wherein the glass film is moved in a state of being suctioned onto the suction and support body, and
wherein, in the processing step, a laser beam is radiated to the glass film being moved on the suction and support body, thereby cutting end portions of the glass film in a width direction.
